(19) United States
(12) Patent Application Publication
(10) Pub. No.: US 2011/0205190 A1
(43) Pub. Date: Aug. 25, 2011

(54) KEYPAD RING

(76) Inventors: DIANA A. SPAULDING, Gurnee, IL (US); Ronald E. Spaulding, Gurnee, IL (US)

(21) Appl. No.: 13/022,298

(22) Filed: Feb. 7, 2011

Related U.S. Application Data
(60) Provisional application No. 61/282,515, filed on Feb. 23, 2010.

(51) Int. Cl. G06F 3/033

(52) U.S. Cl. 345/179

(57) ABSTRACT

The keypad ring is configured to be worn on one's thumb to facilitate touching or striking keys on a miniature keypad, miniature keyboard, or other miniaturized data input mechanism of a handheld electronic machine, such as a smart phone, cell phone, media player, or the like. The ring fits over the distal phalange of a user's thumb, the ring having an elongate cylindrical stem extending obliquely therefrom. When the keypad ring is attached to the user's thumb, the user can move the thumb to strike the miniature handheld device keys of the miniature keyboard with the tip of the stem portion of the keypad ring. The keypad ring can be made of materials including, but not limited to, rubber or thermoplastic materials.

### CROSS-REFERENCE TO RELATED APPLICATION

This application claims the benefit of U.S. Provisional Patent Application Ser. No. 61/282,515, filed Feb. 23, 2010.

### BACKGROUND OF THE INVENTION

1. Field of the Invention

The present invention relates to devices for manipulating the keys on a keypad or keyboard, and more particularly to a keypad ring that can be worn on one's thumb to facilitate touching, pressing, punching, or striking keys on a miniaturized keypad, miniaturized keyboard, or the like, particularly to facilitate text messaging.

2. Description of the Related Art

Handheld electronic devices having miniaturized touch sensitive screens, miniaturized keyboards or miniaturized keypads include a plethora of cell phones, smart phones, media players, and the like. Typically, the user cradles the handheld electronic device with his/her left hand, right hand, or both, with one or both thumbs poised to strike the miniature keypad or keyboard. The user then uses his/her thumb tips to strike the keys for data entry or texting on the handheld electronic device. For a variety of reasons, this texting posture is not ergonomically efficient. A pencil shaped, handheld stylus would not solve the ergonomic efficiency problem because it would require the user to further contort his/her hand for data entry while juggling the handheld electronic device with the other hand. Such activity may result in misplacement or loss of the pencil shaped stylus especially in crowded environments where most people seem to have a penchant for texting.

Moreover, the thumb tip use is only practicable with people having average to small sized thumb distal phalanges. Unfortunately, there are some big-boned people having very blunt thumb tips who have extreme difficulty in accurately texting in this manner. Additionally, large and small-boned people alike usually complain that they cannot position their thumbs with sufficient accuracy to locate specific keys on the keyboard, keypad, touch-screen window, and the like.

Thus, a keypad ring solving the aforementioned problems is desired.

### SUMMARY OF THE INVENTION

The keypad ring is a one-piece device comprised of a ring that fits over the distal phalange of a user's thumb, the ring having an elongate, cylindrical stem extending therefrom. The stem enables the wearer to more easily interface with small keyboards, keypad devices, and the like. The keypad ring allows a user to enter data on a keypad, keyboard or on a touch screen without having to hold a separate, bulky stylus or pen-type implement. The keypad ring can be molded in one piece from thermoplastic material, a single type of material, more than one type of material, a composite material, a blended material, or the like.

These and other features of the present invention will become readily apparent upon further review of the following specification and drawings.

### BRIEF DESCRIPTION OF THE DRAWINGS

FIG. 1 is a side perspective view of a keypad ring according to the present invention.

FIG. 2 is an environmental, perspective view of the keypad ring according to the present invention.

Similar reference characters denote corresponding features consistently throughout the attached drawings.

### DETAILED DESCRIPTION OF THE PREFERRED EMBODIMENTS

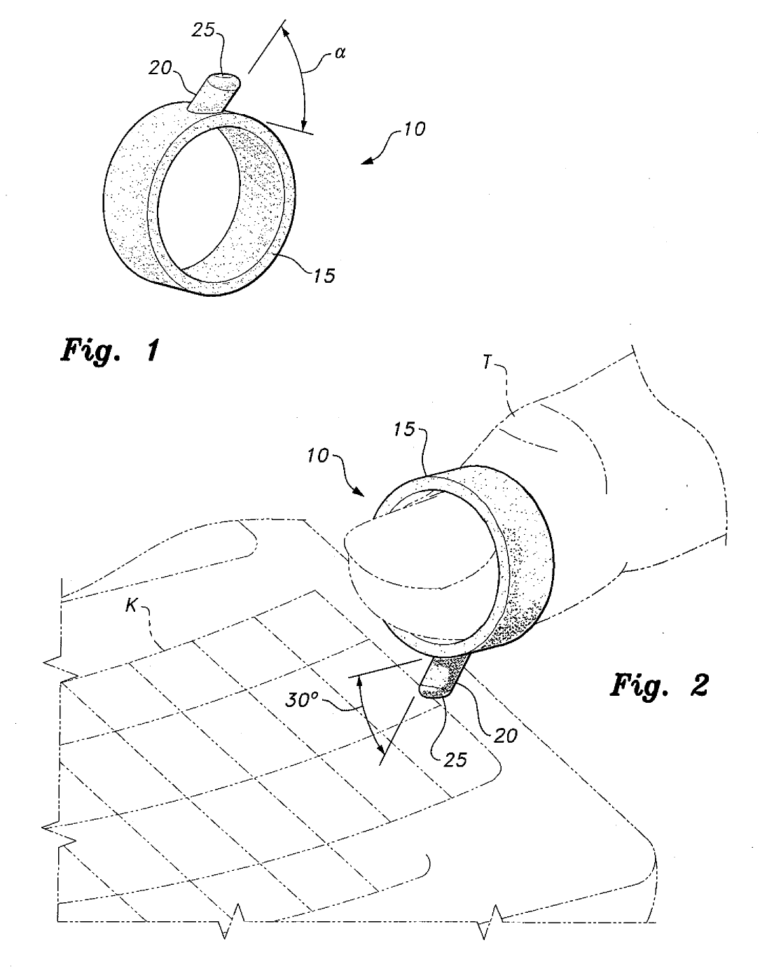

As shown in FIGS. 1 and 2, the keypad ring 10 is a texting aid comprised of a ring 15 having a cylindrical stem 20 extending obliquely from the ring 15. A user wears the ring 15 over a comfortable position on a distal phalange of his/her thumb T. The design of ring 15 allows for fast and easy placement and removal from the thumb T, which gives comfort and convenience. When the keypad ring 10 is attached to the thumb T, the user can move the thumb T to strike the miniature handheld device keys of a keypad K with the stem 20 extending from the ring 15 of the keypad ring 10.

The ring portion 15 is preferably made of a moderately hard, form-fitting rubber, or other resiliently flexible material, e.g., a thermoplastic material. The ring 15 is designed to form-fit snugly around the tip or knuckle (distal phalange joint) of the thumb T, depending on personal preference of the user.

The cylindrical stem 20 is pitched down from the ring's central axis (an axis running parallel to the ring sidewalls) at an angle α, preferably approximately 30°. The 30° pitch allows the stem 20 to face downward against the miniature keypad K when the thumb T assumes a natural and ergonomic position over the handheld device, and thus helps to facilitate the user seeing past the thumb T to identify the correct key of the keypad K to press. The cylindrical shape of the stem 20 is stronger and has more gripping power than the design of a typical stylus would allow for.

By fitting the ring portion 15 of the keypad ring 10 around the knuckle portion on the thumb T, repetitive bending of this joint may be eliminated, therefore allowing the stronger muscles in the hand to move the thumb T, which guides the striking action of the stem 20. Moreover, the stem 20 removes the need to press the small keys with the much larger surface of the thumb T.

The beveled, slightly concave, semi-soft, rubber-like tip 25 of the stem 20 adds gripping power and has a sufficiently high coefficient of friction to prevent slippage when pressing the keyboard K. Thus, the small, rubber-like tip 25 makes it easy to accurately press the correct key of keyboard K. For maximum speed, a keypad ring 10 would be placed on a user's left and right thumb T. The compact size of the keypad ring 10 allows for the device 10 to easily fit into a pocket, unlike other devices with their bulkier sizes. Users should not text while operating vehicles, heavy machinery, and the like.

It is to be understood that the present invention is not limited to the embodiment described above, but encompasses any and all embodiments within the scope of the following claims.

We claim:

1. A keypad ring, comprising a ring adapted for slipping snugly over a distal phalange of a wearer's thumb, the ring having a cylindrical stem extending obliquely from the ring, the cylindrical stem ending in a beveled, concave tip.

2. The keypad ring according to claim 1, wherein said obliquely extending cylindrical stem slopes downward and forward from said ring at an angular pitch of about thirty degrees.

3. The keypad ring according to claim 1, wherein said stem tip is made of a resilient material having a sufficiently high coefficient of friction to prevent slippage when the tip is used to press a key on a keypad.

4. The keypad ring according to claim 1, wherein said keypad ring is made of a thermoplastic material.

5. The keypad ring according to claim 1, wherein said keypad ring is made of a rubber material.
